(19) United States
(12) Patent Application Publication
(10) Pub. No.: US 2024/0365704 A1
(43) Pub. Date: Nov. 7, 2024

(54) CROP RESIDUE SPREAD MONITORING AND CONTROL SYSTEM AND METHOD

(71) Applicant: Deere & Company, Moline, IL (US)

(72) Inventors: Nathan R. Vandike, Geneseo, IL (US); Martin Franz Unterpaintner, Saarbruecken (DE)

(21) Appl. No.: 18/311,479

(22) Filed: May 3, 2023

(51) Int. Cl. A01D 41/127; A01D 41/12

(52) U.S. Cl. CPC A01D 41/127; A01D 41/1252; G06Q 50/02

(57) ABSTRACT

A residue spread monitoring system for an agricultural harvester includes sensors and a controller configured to receive images from the sensors and determine a mode of plume evaluation as a first mode of plume evaluation or a second mode of plume evaluation; determine, in the first mode of plume evaluation, a first spread of the plume of residue based on the residue within the one or more first images; measure, in the second mode of plume evaluation, one or more first characteristics of dust represented in the one or more first images; and process, in the second mode of plume evaluation, the one or more first characteristics of dust is used to obtain the first spread of the plume of residue; and control operation of the agricultural harvester according to the first spread of the plume of residue.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates generally to agricultural combines. In particular, it relates to systems and methods for monitoring crop residue.

### BACKGROUND OF THE DISCLOSURE

Crop residue is a byproduct of a crop harvesting operation. Crop residue may include straw, chaff or other unwanted portions of a crop plant following threshing and/or separation processes by a harvester. Crop residue may additionally include other biomass such as weeds, weed seeds and the like. Such residue is often discharged from the harvester.

### SUMMARY OF THE DISCLOSURE

In one aspect, a residue spread monitoring system for an agricultural harvester is disclosed. In embodiments, the agricultural harvester includes one or more sensors mounted to one or more locations on the agricultural harvester. A controller is configured to receive one or more first images from the one or more sensors and determine a mode of plume evaluation as a first mode of plume evaluation or a second mode of plume evaluation. In the first mode of plume evaluation, a first spread of the plume of residue is based on the residue within the one or more first images. In the second mode of plume evaluation, one or more first characteristics of dust represented in the one or more first images is measured; and the one or more first characteristics of dust is used to obtain the first spread of the plume of residue is processed. Operation of the agricultural harvester is controlled according to the first spread of the plume of residue.

In some instances, the controller is further configured to: determine a visibility of the plume of residue from the one or more first images. In response to determining that the visibility of the plume of residue satisfies a threshold condition as being visible, the controller determines the mode of plume evaluation as the first mode of plume evaluation; and in response to determining that the visibility of the plume of residue fails to satisfy the threshold condition such that the plume of residue is not visible in the one or more first images, the controller determines the mode of plume evaluation as the second mode of plume evaluation.

In some instances, the one or more first characteristics of dust include at least one of location or movement.

In some instances, the first spread of the plume of residue includes at least one of a location, a width, or a direction or movement of the plume of residue.

In some instances, the controller is configured to control the operation of the agricultural harvester according to the first spread by controlling at least one of a speed or a position of a spreader mechanism.

In some instances, the controller is configured to control the operation of the agricultural harvester according to the first spread by controlling at least one of chopper operation, harvester speed, or harvester head operation.

In some instances, the controller is further configured to receive one or more second images from the one or more sensors mounted to the agricultural harvester prior to receiving the one or more first images and measure a second spread of a plume of residue of the agricultural harvester by analyzing the one or more second images. The controller is further configured to identify dust represented in the one or more second images and measure one or more second characteristics of the dust represented in the one or more second images. The controller is further configured to train, using the second spread of the plume of residue and the one or more second characteristics, a spread prediction module to output a spread prediction for the plume of residue. The controller is further configured to, in response to determining that the visibility of the plume of residue fails to satisfy the threshold condition such that the plume of residue is not visible in the one or more first images, process the one or more first characteristics of dust to obtain the first spread of the plume of residue by processing the one or more first characteristics using the spread prediction module.

In some instances, the one or more sensors include one or more cameras.

In some instances, the one or more cameras may include at least one rearward pointing camera positioned above a spreader mechanism of the agricultural harvester.

In a further aspect, a method for predicting residue spread by an agricultural harvester includes receiving, by a controller, one or more first images from one or more sensors mounted to the agricultural harvester. The method further includes determining, by the controller, a mode of plume evaluation as a first mode of plume evaluation or a second mode of plume evaluation; determining, by the controller in the first mode of plume evaluation, a first spread of the plume of residue based on the residue within the one or more first images; measuring, by the controller in the second mode of plume evaluation, one or more first characteristics of dust represented in the one or more first images and processing, by the controller in the second mode of plume evaluation, the one or more first characteristics of dust to obtain a first spread of the plume of residue; and controlling, by the controller, operation of the agricultural harvester according to the first spread.

In some instances, the method further includes evaluating a visibility of the plume of residue from the one or more first images. The determining, by the controller, the mode of plume evaluation as the first mode of plume evaluation or the second mode of plume evaluation includes: determining the mode of plume evaluation as the first mode of plume evaluation when the visibility of the plume of residue satisfies a threshold condition as being visible; and determining the mode of plume evaluation as the second mode of plume evaluation when the visibility of the plume of residue fails to satisfy the threshold condition such that the plume of residue is not visible in the one or more first images.

In some instances, the method further includes receiving, by the controller, one or more second images from the one or more sensors; determining, by the controller, that the plume of residue emitted from the agricultural harvester is visible in the one or more second images; and in response to determining that the plume of residue is visible in the one or more second images, determining a second spread of the plume of residue based on the residue within the one or more second images and controlling, by the controller, operation of the agricultural harvester according to the second spread.

In some instances, the first characteristics include at least one of location or movement of dust.

In some instances, the first spread of the plume of residue includes at least of a location, a width, or a direction of movement of the plume of residue.

In some instances, the method includes controlling, by the controller, the operation of the agricultural harvester according to the first spread by controlling at least one of a speed or a direction of a spreader mechanism.

In some instances, the method includes controlling, by the controller, the operation of the agricultural harvester according to the first spread by controlling one or more of chopper operation, harvester speed, or harvester head operation.

In some instances, the method further includes receiving, by the controller, one or more third images from the one or more sensors mounted to the agricultural harvester prior to receiving the one or more first images and measuring, by the controller, a third spread of a plume of residue of the agricultural harvester by analyzing the one or more third images. The method further includes identifying, by the controller, dust represented in the one or more third images and measuring, by the controller, one or more second characteristics of the dust represented in the one or more third images. The method includes training, by the controller, using the third spread of the plume of residue and the one or more second characteristics, a spread prediction module to output a spread prediction for the plume of residue. The method may include processing the one or more first characteristics to obtain the first spread of the plume of residue by processing, by the controller, the one or more first characteristics using the spread prediction module.

In some instances, the one or more sensors include one or more cameras, including at least one rearward pointing camera positioned at a height greater than that of a spreader mechanism of the agricultural harvester.

In a further aspect, a residue spread prediction system for an agricultural harvester is also disclosed. The residue spread prediction system includes one or more sensors mounted to one or more locations on the agricultural harvester. The system includes a controller configured to: receive one or more first images from the one or more sensors; measure a first spread of a plume of residue of the agricultural harvester by analyzing the one or more first images; identify dust represented in the one or more first images; measure one or more first characteristics of the dust represented in the one or more first images; and train, using the first spread of the plume of residue and the one or more first characteristics, a spread prediction module to output a spread prediction for the plume of residue.

In some instances, the one or more first characteristics include at least one of location or movement; and the first spread of the plume of residue includes at least one of a location, a width, or a direction of the plume of residue,

### BRIEF DESCRIPTION OF THE DRAWINGS

FIG. 1 is a side view of an agricultural harvester for use with a residue spread monitoring and control system in accordance with the present disclosure;

FIG. 2 is a plan view of the agricultural harvester of FIG. 1;

FIG. 3 is a schematic diagram of the residue spread prediction system of FIGS. 1-2 in accordance with an example embodiment;

FIG. 4 is a schematic diagram of components of an ECU implementing the residue spread prediction system in accordance with an example embodiment;

FIG. 5 is a process flow diagram of a method for predicting and controlling the spread of crop residue in accordance with an example embodiment; and

FIG. 6 is an image that may be processed to facilitate prediction of the spread of crop residue in accordance with an example embodiment.

Like reference symbols in the various drawings indicate like elements.

### DETAILED DESCRIPTION

The following describes one or more example embodiments of the disclosed crop residue monitoring and control system and method, as shown in the accompanying figures of the drawings described briefly above. Various modifications to the example embodiments may be contemplated by one of skill in the art. Discussion herein may sometimes focus on the example application in an agricultural harvester, but the disclosed system and method are applicable to other types of work vehicles and/or other types of work environments.

As noted, there are a wide variety of different types of agricultural machines, forestry machines, and/or construction machines. As examples, some agricultural machines include harvesters, such as combine harvesters, sugar cane harvesters, cotton harvesters, self-propelled forage harvesters, and windrowers. Harvest operations may involve various types of systems and management mechanisms in order to improve overall performance and production.

Agricultural harvesters travel through fields of agricultural crop harvesting the crop. In one common arrangement, agricultural harvesting heads extend forward from the spreading mechanism of the agricultural harvester to engage the plant stalks, sever them, and carry the severed crop into the body of the agricultural harvester itself for further processing. Threshing, cleaning and separating mechanisms inside the agricultural harvester are provided to separate grain from material other than grain (e.g., to result in “crop residue”), such as straw. Once separated, the crop residue is carried to the rear of the combine, chopped, and spread over the ground behind the combine. A common issue when spreading crop residue behind the agricultural harvester is accurately monitoring the spread of the crop residue, particularly when there are strong prevailing winds. Generally, the spread of residue released into the air and settling onto the ground may be considered a plume of residue. The plume of crop residue is thrown to the rear of the vehicle and the wind carries the crop residue from side to side.

Control systems are provided to monitor the spread of the crop residue behind the agricultural harvester and to control fans, vanes, and other steering devices to ensure that the crop residue is properly distributed on the ground behind the agricultural harvester. These control systems include cameras or other sensors (herein “cameras”) are disposed to sense the characteristics and location of the crop residue in the field behind the agricultural harvester.

The process of spreading the crop residue produces or otherwise results in a lot of dust, however. This dust obscures the view of the cameras, and thus prevents the control system from accurately determining the spread of the crop residue on the ground. In addition, shadows cast by the agricultural harvester or other structures may also obscure a view of the crop residue on the ground. Generally, dust, shadows, or other impediments may present challenges with respect to accurately monitoring the crop residue.

According to the disclosure herein, a system (and method) for predicting, monitoring, and/or evaluating crop residue spread may be provided. As an example, the system may receive images from one or more cameras, such as from a rearward facing camera mounted to the agricultural harvester. The system may be considered to operate in two or more modes of plume evaluation. In particular, if an image sufficiently depicts the residue, the system may operate in a first mode of plume evaluation in which the spread of residue is estimated based on the residue. If an image indicates that dust is present in the view of the crop residue (e.g., to obscure the residue), the system may operate in a second mode of plume evaluation in which the plume characteristics may be estimated from observation of the dust, which may be used to determine the location and movement of the crop residue, thereby enabling a more precise control of the crop residue system. In particular, a prediction module may be trained to relate the location and movement of the dust to the spread of the crop residue. As such, even if the crop residue is not sufficiently visible in an image due to being obscured by dust, the prediction module uses the location and movement of the dust to predict the spread of the crop residue. The spread of the crop residue, whether predicted or determined directly from an image, is then used to control the spreading of the crop residue by the agricultural harvester.

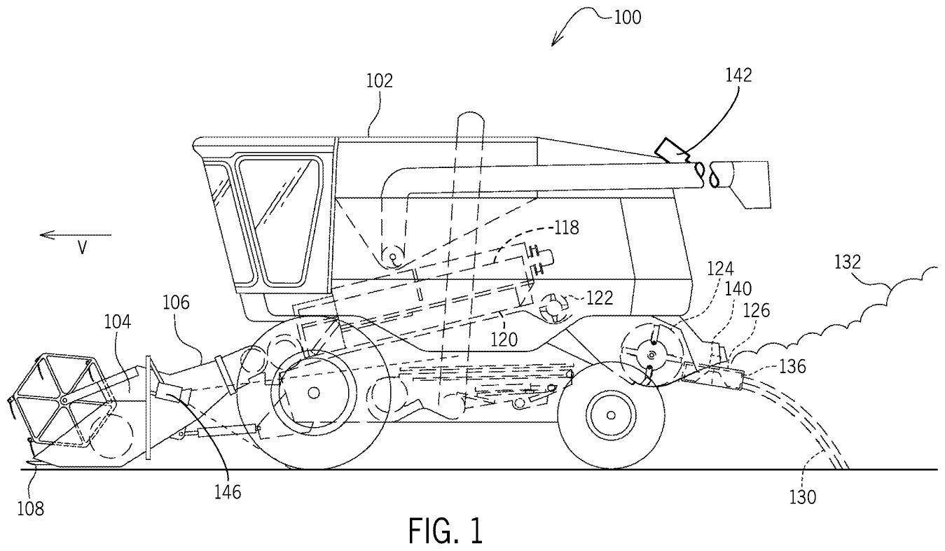

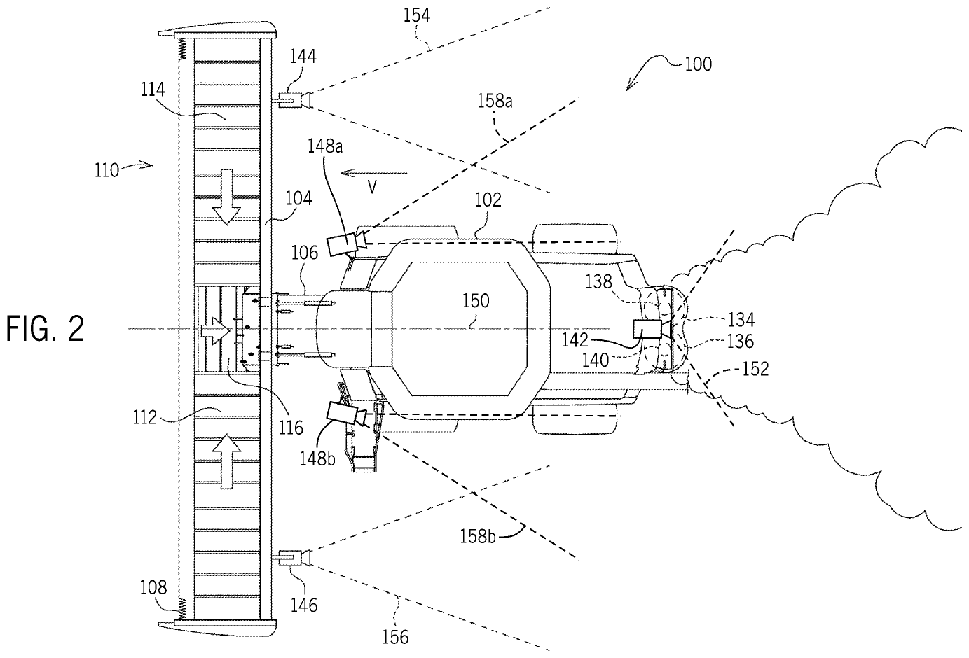

Referring to FIGS. 1 and 2, a work vehicle implementing the system and methods disclosed herein may be embodied as the illustrated agricultural harvester 100 or other type of work vehicle. The illustrated agricultural harvester 100 may include a self-propelled agricultural harvesting vehicle 102 and an agricultural harvesting head 104 supported on the front of the agricultural harvesting vehicle 102. The agricultural harvesting vehicle 102 includes a feederhouse 106 that is coupled to the forward end of the agricultural harvesting vehicle 102 and to which is coupled the agricultural harvesting head 104.

The agricultural harvesting head 104 includes a reciprocating knife 108 that is fixed to and extends across the front of the agricultural harvesting head 104. Behind the reciprocating knife 108 is a conveyor system 110, which comprises a left side conveyor 112, right side conveyor 114 and a center conveyor 116. The left side conveyor 112 has an endless belt upon which material cut by the reciprocating knife falls. This cut crop material is carried inwardly toward a central region of the agricultural harvesting head. The right side conveyor 114 has an endless belt upon which material cut by the reciprocating knife falls. This cut crop material is carried inwardly toward central region of the agricultural harvesting head 104. The center conveyor 116 is disposed between the left side conveyor 112 and the right side conveyor 114, receives crop from both, and carries the crop rearward into an opening at the forward end of the feederhouse 106. The feederhouse 106 includes an internal conveyor (not shown) that lifts the cut crop material up and carries it into the body of the agricultural harvesting vehicle 102. Once received in the body of the agricultural harvesting vehicle 102, the cut crop material is conveyed into a gap between an elongate rotor 118 and a concave grating 120. The cut crop material is threshed and separated between the elongate rotor 118 and the concave grating 120 as the rotor rotates against the stationary concave grating.

Upon separation from the grain, the remaining material, as “residue,” is carried rearward in the gap between the elongate rotor 118 and the concave grating 120 until the exiting adjacent to a beater 122. The crop residue is beaten by the beater 122 to separate any remaining kernels of grain from the crop residue. The crop residue then falls downward and rearward into a chopper 124. The chopper 124 comminutes the crop residue into smaller portions for easier distribution over the ground and easier digestion by microbes in the soil.

Comminuted crop residue is thrown rearward by the chopper 124 into a spreader mechanism 126. The spreader mechanism 126 may be a powered or non-powered spreading device. It may include one or more motor-driven rotating discs with paddles or vanes, or it may include stationary paddles, vanes, or shrouds that steer the residue laterally, from side to side. In either case, whether driven or non-driven, the spreader mechanism 126 spreads the crop residue out into a broad fan like pattern behind the agricultural harvesting vehicle 102.

The spreader mechanism 126 may include two spinning discs 134, 136 driven by motors 138, 140. These spinning discs have downwardly extending vanes that engage the chopped residue and fling it outward and rearward to both sides of the agricultural harvesting vehicle 102.

Upon release at the outlet of the spreader mechanism 126, the plume of residue 130 in the air may settle to the ground behind the agricultural harvesting vehicle 102. In some examples, the spread of residue in the air and the residue on the ground may be considered the plume of residue 130. Air may carry dirt and other debris such that a cloud of dust 132 may be mixed in with the residue as the residue falls downward under the force of gravity onto the ground. Additional details regarding the residue and cloud of dust 132 are provided below.

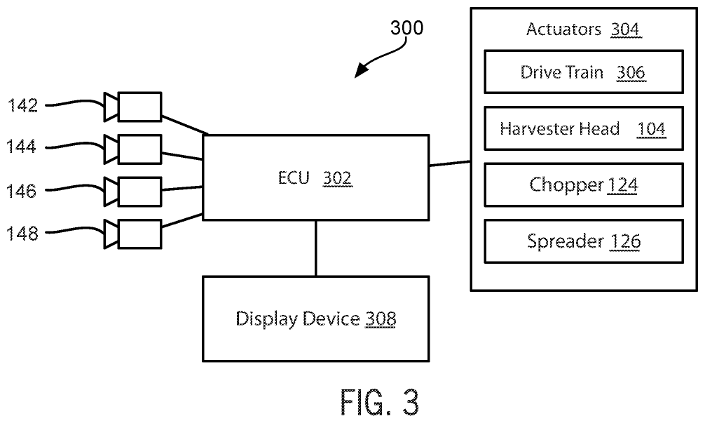

The agricultural harvester 100 may include a number of cameras 142, 144, 146, 148a, 148b mounted at various locations. The cameras 142, 144, 146, 148a, 148b may be of multiple types having a different imaging modality or multiple different imaging modalities. For example, the cameras may include visible light cameras or infrared cameras. Other imaging modalities may include light detection and ranging (LIDAR), radio detection and ranging (RADAR), ultrasonic imaging, ultraviolet imaging, or other imaging modality. In any event, the cameras 142, 144, 146, 148a, 148b may produce digital or analog signals representing images of the plume of residue 130 within their fields of view. The cameras 142, 144, 146, 148a, 148b are coupled to one or more computing devices (e.g., an ECU 302, such as depicted in FIG. 3 and described below) to receive images of the plume of residue 130.

As shown in FIG. 2, one or more cameras 142 may be mounted to the sides or roof of the agricultural harvesting vehicle 102 above the spreader mechanism 126. A camera 144 may be provided on the right-hand side of the agricultural harvesting head 104, and a camera 146 may be provided on the left-hand side of the agricultural harvesting head 104. One or more additional cameras 148a, 148b may be mounted to the mirrors of the agricultural harvesting vehicle 102.

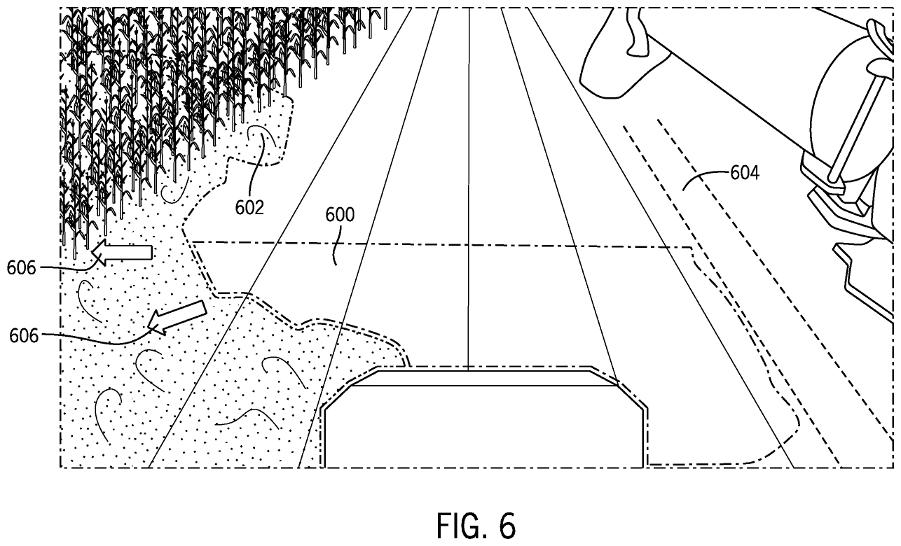

The camera 142 may have a field of view 152 encompassing substantially all (e.g., at least 90 percent) of the plume of residue 130 absent wind or other disturbance directing the plume of residue 130 to the right or left of the agricultural harvester 100 (“the undisturbed plume of residue 130”). An example image that might be captured using the camera 142 is shown in FIG. 6, described in greater detail below.

Still referring to FIGS. 1 and 2, the field of view 152 of the camera 142 may be substantially centered (e.g., within 5 degrees) on a fore and aft plane 150 of the agricultural harvester 100. The camera 144 has a field of view 154 and camera 146 has a field of view 156, both of which have at least part of the undisturbed plume of residue 130 in the field of view thereof. The field of view 154 of camera 144 may extend outside of the field of view 152 of the camera 142 in the vicinity of the plume of residue 130. In this way, camera 144 overlaps and extends the field of view of camera 142. In a similar fashion, the field of view 156 of camera 146 extends outside of the field of view 152 of the camera 142. Likewise, the field of view 156 of the camera 146 overlaps and extends the field of view 152 of the camera 142. One or more cameras 148a, 148b mounted to one or more mirrors may likewise have fields of view 158a, 158b that image at least a portion of the undisturbed plume of residue 130 and possibly extend the field of view 152 of the camera 142.

The field of view of the camera 142 permits the system to image substantially the entire width of the plume of residue 130 falling from the agricultural harvester 100 as well as the ground behind the agricultural harvester 100 over which the plume of residue 130 is scattered. The other cameras 144, 146, 148a, 148b may also collectively image the plume of residue 130 and the ground behind the agricultural harvester sufficiently to determine the spread of the plume of residue 130.

As described below, one or more of the images from the cameras 142, 144, 146, 148a, 148b may be analyzed to determine the spread of the plume of residue 130. When the one or more images are partially obscured by dust, the movement and location of the dust in the one or more images may be determined as well as the spread of the plume of residue 130. A prediction module may be trained using the movement and location of the dust and the spread of the plume of residue 130 to predict the spread of the plume of residue 130 based on the movement and location of the dust.

When the field of view of one or more of the cameras 142, 144, 146, 148a, 148b is obscured by dust such that the spread of the plume of residue 130 cannot be estimated directly from the one or more images, the spread of the plume of residue 130 may be predicted based on the movement and location of dust represented in the one or more images.

Generally, and also discussed in greater detail below, the spread of the plume of residue 130 may be represented by physical characteristics of the plume of residue 130 extracted from the one or more images. These characteristics may include characteristics of the distribution of the plume of residue 130, such as a location, spread edge, a width of the plume of residue 130 and a direction of the plume of residue 130 behind the agricultural harvester 100, e.g., how far to the right and/or how far to the left of the agricultural harvester 100. These characteristics may include characteristics of the crop residue itself, including a numerical statistic of the crop residue (e.g., average residue/straw length), a categorization of the crop residue (e.g., type of crop residue, percent of different types of crop residue, the like), and/or processing characteristics (e.g., under processed, over processed, and the like that refers to the degree to which the crop residue has been changed or reduced in size by the harvester).

Referring to FIG. 3, a system 300 for residue spread prediction includes a controller, such as the ECU 302, which is coupled to or otherwise considered to include some or all of the cameras 142, 144, 146, 148a, 148b and receives digital or analog signals from some or all of the cameras 142, 144, 146, 148a, 148b representing images. The system 300 may additionally be considered to include or otherwise cooperate with one or more actuators 304 (e.g., a drive train 306, agricultural harvesting head 104, chopper 124, and/or spreader mechanism 126) and/or one or more display devices 308.

Generally, the ECU 302 may be a controller that implements operation of the residue spread prediction system 300, as well as other systems and components of the agricultural harvester 100, including any of the functions described herein. The ECU 302 may be configured as computing devices with associated processor devices and memory architectures. For example and as described below, the ECU 302 may implement functional modules or units with the processor based on programs or instructions stored in memory. In some examples, the consideration and implementation of aspects of the residue spread prediction system 300 by the ECU 302 are continuous, e.g., constantly active. In other examples, the activation may be selective, e.g., enabled or disabled based on input from the operator or other considerations.

As noted, the ECU 302 is further coupled to one or more actuators 304 for controlling operation of the agricultural harvester 100 in response to analysis of the images by the ECU 302. For example, the one or more actuators 304 may include the drive train 306 of the agricultural harvester 100. The drive train 306 may include a prime mover, such as an internal combustion engine (gasoline, diesel, natural gas, propane, etc.) or an electric motor. The drive train 306 may further include a transmission for transmitting torque between the prime mover and wheels or tracks of the agricultural harvester 100. The one or more actuators 304 may include the agricultural harvesting head 104, e.g., actuators for driving the height of the harvesting head 104 or controlling other aspects of the agricultural harvesting head 104. The one or more actuators 304 may further include the chopper 124 and spreader mechanism 126.

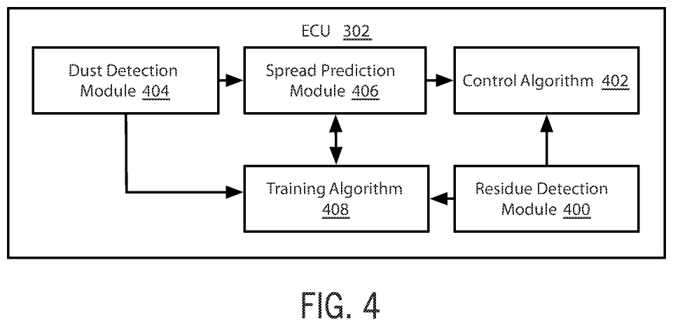

As also noted, the ECU 302 may further be coupled to the display device 308. The display device 308 may be located in a cab of the agricultural harvester 100 or be remote from the agricultural harvester 100, such as in the case of an agricultural harvester 100 that operates autonomously or by remote control. Operation of the ECU 302 to implement the residue spread prediction system 300 is discussed in greater detail with FIG. 4.

Reference is now made to FIG. 4, which illustrates exemplary components of an ECU 302 that may be used to predict spreading of crop residue and control the spreading of crop residue. As introduced above and depicted in FIG. 4, aspects of the residue spread prediction system 300 may be organized within the ECU 302 as one or more functional systems, units, or modules 400, 402, 404, 406, 408 (e.g., software, hardware, or combinations thereof), including residue detection module 400, a control algorithm 402, a dust detection module 404, a spread prediction module 406, and a training algorithm 408. As can be appreciated, the functional systems, units, or modules 400, 402, 404, 406, 408 shown in FIG. 4 may be combined and/or further partitioned to carry out similar functions to those described herein.

The functional systems, units, or modules 400, 402, 404, 406, 408 shown in FIG. 4 operate with respect to images from some or all of the cameras 142, 144, 146, 148a, 148b. In the following description, reference is made to a “stream of images” and a “subject image.” The stream of images includes a series of images captured sequentially at different times, such as frames of a video feed. The “subject image” refers to an individual image of the stream of images that is evaluated according to the system and method described herein. The stream of images may be a stream of images from a single camera, e.g., the camera 142, or a composite stream of images comprising a set of images from two or more of the cameras 142, 144, 146, 148a, 148b for each time point represented in the stream of images. Likewise, the subject image may be a single image from a single camera, e.g., camera 142, or a set of multiple images from multiple cameras 142, 144, 146, 148a, 148b.

The ECU 302 may be configured with a residue detection module 400. The residue detection module 400 processes images from the stream of images as the subject image. The residue detection module 400 processes the subject image to identify portions of the subject image representing the plume of residue 130. The residue detection module 400 further processes the identified portions of the subject image to determine the spread of the plume of residue 130. The spread of the plume of residue 130 may be represented as some or all of a location, a spread edge, a width of the plume of residue 130, and direction in which the plume of residue 130 is falling on the ground behind the agricultural harvester 100, e.g., how far to the right and/or how far to the left of the agricultural harvester 100. The residue detection module 400 may be implemented as one or more machine vision algorithms that determine the spread of the plume of residue 130 in the subject image. The residue detection module 400 may alternatively or additionally include one or more machine learning models trained to identify the plume of residue 130 and determine the spread of the plume of residue. The one or more machine learning models, and any other machine learning models references herein, may be implemented as a Bayesian network, genetic algorithm, multiple linear regression model, multivariate polynomial regression model, support vector regression model, neural network, deep neural network, convolution neural network, or any other type of machine learning model.

The ECU 302 may be configured with a control algorithm 402. The spread of the plume of residue 130 is provided to the control algorithm 402, which uses the spread of the plume of residue 130 as feedback to control the one or more actuators 304 to more closely achieve desired properties of the plume of residue 130, such as having a desired width and being centered on the fore and aft plane 150. For example, the spreader mechanism 126 may be accelerated if the width of the plume of residue 130 is too narrow or decelerated if the width is too large relative to a desired width. The spreader mechanism may be repositioned in one or more ways, including the position of one or more vanes or a shroud of the spreader mechanism 126 that may be adjusted to move the plume of residue 130 to the right (or the left) where the plume of residue 130 is off center to the left (or to the right). A difference in the speeds of the spinning disks 134, 136 may be adjusted to change the direction of the plume of residue 130. The speed of rotation of the agricultural harvesting head 104 and/or chopper 124 may be increased or decreased based on the spread of the plume of residue 130. The drive train 306 may be directed to slow down or speed up based on the spread of the plume of residue 130.

The ECU 302 may be configured with a dust detection module 404. The dust detection module 404 processes images from the stream of images as the subject image. The dust detection module 404 processes the subject image to identify portions of the subject image representing dust, such as airborne dust. The dust detection module 404 further processes the identified portions of the subject image to determine a location and movement of the dust. The dust detection module 404 may be implemented as one or more machine vision algorithms that identify dust in the subject image and determine the location and movement of the dust. The dust detection module 404 may alternatively or additionally include one or more machine learning models trained to identify dust in the subject image and determine the location and movement of the dust.

In some examples, the dust detection module 404 may detect a location of the dust with a segmentation mask that indicates pixels of the subject image determined to correspond to dust. The location of the dust may include a characterization of the location of the dust, e.g., a location of a centroid of the portion of the image determined to represent dust, a curve or line representing a left and/or right boundary of the portion of the image determined to represent dust, or some other characterization.

Moreover, the dust detection module 404 may detect the movement of the dust that includes a speed and/or direction of movement of the dust. To determine movement, two or more images in the stream of images may be evaluated by the dust detection module 404, such as the subject image and one or more preceding images of the stream of images, such as an immediately preceding image. For example, the location of the dust identified in the subject in the subject image may be compared to the location of the dust identified in a preceding image in the stream of images in order to determine the movement, speed of movement, and/or direction of movement of the dust. For example, any approach for performing image-based motion tracking as known in the art may be used to determine the movement, speed of movement, and/or direction of movement of the dust based on the dust identified in the subject image and the dust identified in the preceding image.

The ECU 302 may be configured with a spread prediction module 406 and a training algorithm 408. The output of the dust detection module 404 and the output of the residue detection module 400 may be provided to the training algorithm 408. The training algorithm 408 trains the spread prediction module 406 to predict the spread of the plume of residue 130 based on at least one of the location of dust in the subject image and the movement of dust in at least two subject images in certain circumstances.

As introduced above, the ECU 302 may be configured to operate one or more modules 400, 402, 404, 406, 408 based on the amount of dust and/or the visibility of the residue, e.g., within modes of plume evaluation. As an example, if the residue detection module 400 determines that visibility of the plume of residue 130 of a subject image meets a threshold condition, the residue detection module 400 may operate in a first mode of plume evaluation, determining the spread of the plume of residue 130 and providing the spread of the plume of residue to the control algorithm. For example, the threshold condition may be at least X percent of the width of the plume of residue 130 measured perpendicular to the fore and aft plane 150 is visible, where X is a preconfigured parameter such as value between 50 and 90. The threshold condition may be a function of the amount of dust detected by the dust detection module 404: less than Y percent of a region of the subject image being occupied by dust or other obscurants, where the region is a predefined region of the subject image where the plume of residue 130 is typically represented.

The dust detection module 404 further determines for the same subject image whether dust is represented in the subject image and, if so, determines the location and movement of the dust. If dust is represented in the subject image and the residue detection module 400 outputs a spread of the plume of residue 130 for the subject image, the training algorithm 408 uses the location and movement of the dust and the spread of the plume of residue 130 to train the spread prediction module 406. The training algorithm 408 trains the spread prediction module 406 to output a predicted residue spread for a given input of dust location and movement. The spread prediction module 406 may be implemented as a machine learning model and the training algorithm 408 may be a training algorithm corresponding to a type of the machine learning model.

As a further example of a mode of plume evaluation, if the plume of residue 130 does not meet the threshold condition for visibility in the subject image, the control algorithm 402 may operate in a second mode of plume evaluation, using a predicted residue spread output by the spread prediction module 406 for the subject image, which is based on at least one of the movement of dust in the subject image and location of dust in at least two subject images as determined by the dust detection module 404. The control algorithm 402 may then use the predicted residue spread as feedback to control the one or more actuators 304 in the same manner as for the spread of the plume of residue 130 as output by the residue detection module 400 as described above.

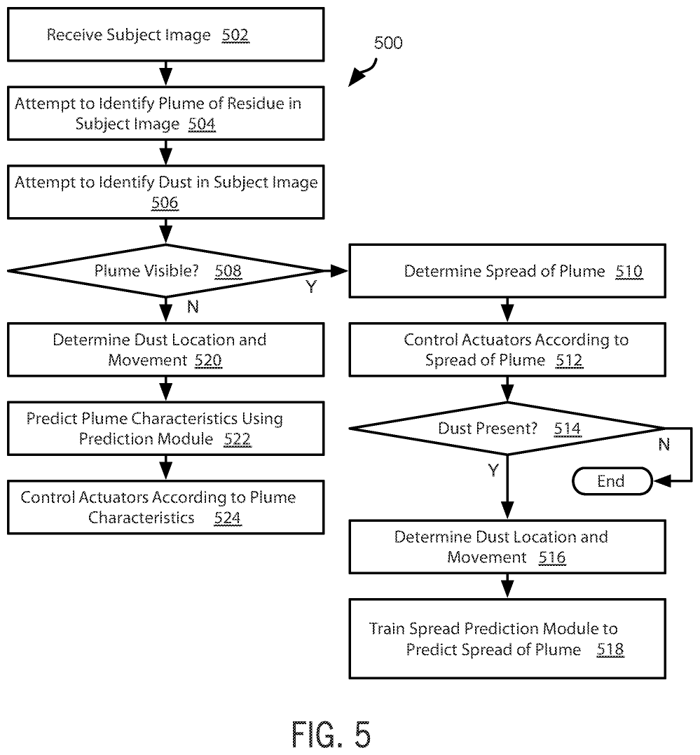

FIG. 5 illustrates a method 500 that may be executed by the ECU 302 or other computing device hosted by the agricultural harvester 100 or remote from the agricultural harvester 100. The method 500 may include receiving, at step 502, the subject image of the stream of images from a single camera, e.g., the camera 142, or as a set of images from multiple cameras 142, 144, 146, 148a, 148b. Reference is again made to FIG. 6, which illustrates an image such as might be captured by the camera 142 and which may be used as the subject image.

The subject image may be processed at step 504 to attempt to identify the plume of residue 130 in the subject image and, at step 506, to attempt to identify dust in the subject image. For example, referring to FIG. 6, step 504 may identify region 600 as corresponding to the plume of residue 130 and step 506 may identify region 602 as corresponding to dust. Steps 504 and 506 may be implemented using the residue detection module 400 and dust detection module 404, respectively, as described above.

At step 508, the method 500 includes determining whether visibility of the plume of residue 130 in the subject image meets a threshold condition. As noted above, step 508 may include determining whether a threshold condition is met, such as at least X percent of the width of the plume of residue 130 being visible or less than Y percent of a predefined region of the subject image being occupied by dust or other obscurants.

If visibility of the plume of residue 130 meets the threshold condition of step 508, the spread of the plume of residue 130 is determined at step 510. As noted above, the spread of the plume of residue 130 may include a location, a spread edge, a width, and/or a direction of the plume of residue 130. For example, referring to FIG. 6, step 508 may include determining that the residue 130 is absent from lateral region 604 and therefore the spread of the plume of residue 130 is one or both of too narrow and shifted to the right of the agricultural harvester 100 (left side of the image).

At step 512, the one or more actuators 304 are controlled according to the spread of the plume of residue 130 in order to better achieve the desired properties of the plume of residue 130, e.g., closer to a desired width and closer to being centered on the fore and aft plane 150. For example, using the example of FIG. 6, the relative speeds of the spinning discs 134, 136 may be adjusted to shift the direction of the plume of residue 130 to the left of the agricultural harvester 100 (right side of the image) or one or more vanes or a shroud may be adjusted to shift the plume of residue 130 to the left of the agricultural harvester 100.

At step 514, whether dust was identified in the image is evaluated, such as whether dust was detected at step 506. Step 514 may include determining whether the amount of dust detected at step 506 meets a threshold condition, such as the portion of the subject image representing dust being Z percent of the subject image or of the predefined region of the subject image where the plume of residue 130 is typically represented. For example, Z may be a percentage that is less than the percentage Y used to determine whether the plume of residue 130 is sufficiently visible.

If dust is not found to be identified at step 514, then the method 500 may end with respect to the subject image.

If dust is found to be identified at step 514, step 516 may include determining the location and movement of dust. The location and movement of the dust may be determined by the dust detection module 404 as described above. For example, referring to FIG. 6, one or more vectors 606 representing the location and/or movement of the dust in the region 602 may be determined. For example, a vector field may be obtained that shows the movement of the dust at an array of locations within the region 602.

At step 518, the location and movement of the dust may then be used to train the spread prediction module 406. Step 518 may include processing the spread of the plume of residue determined at step 510 and the location and movement of the dust determined at step 516 with the training algorithm 408 in order to train the spread prediction module 406 as described above.

If the plume of residue 130 is not found to be visible at step 508, then step 520 is performed, which includes determining the location and movement of the dust represented in the subject image as described above with respect to step 516. At step 522, the spread prediction module 406 processes the location and movement of the dust and outputs a predicted spread of the plume of residue 130. At step 524, the one or more actuators 304 are controlled according to the predicted spread of the plume of residue 130, such as using the approach described above with respect to step 512.

The method 500 may be repeated for each image in the image stream as the subject image or for a subset of the images in the image stream as the subject image, e.g., every Nth image, where N is an integer greater than one. In some embodiments, steps 520-524 are not performed until the spread prediction module 406 has been sufficiently trained, such as after a minimum number of iterations of step 518. Likewise, the process of training the spread prediction module 406 may end at some point such that steps 514-518 are no longer performed. A trained spread prediction module 406 may be installed on other agricultural harvesters 100 that may or may not continue to train the spread prediction module 406 according to steps 514-518.

Various modifications of the system 300 and method 500 may be made. For example, the movement of the dust may be highly influenced by wind speed and direction. Accordingly, in some embodiments, the movement and location of the dust represented in the subject image may be further processed with consideration for additional operational and/or environmental characteristics, such as wind velocity and/or direction.

As will be appreciated by one skilled in the art, certain aspects of the disclosed subject matter may be embodied as a method, system (e.g., a work vehicle control or power system included in a work vehicle), or computer program product. Accordingly, certain embodiments may be implemented entirely as hardware, entirely as software (including firmware, resident software, micro-code, etc.) or as a combination of software and hardware (and other) aspects. Furthermore, certain embodiments may take the form of a computer program product on a computer-usable storage medium having computer-usable program code embodied in the medium.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be non-transitory and may be any computer readable medium that is not a computer readable storage medium and that may communicate, propagate, or transport a program for use by or in connection with an instruction execution system, apparatus, or device.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the work vehicles and the control systems and methods described herein are merely exemplary embodiments of the present disclosure.

For the sake of brevity, conventional techniques related to work vehicle and engine operation, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

The description of the present disclosure has been presented for purposes of illustration and description, but it is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s).

Accordingly, various embodiments and implementations other than those explicitly described are within the scope of the following claims.

What is claimed is:

1. A residue spread monitoring system for an agricultural harvester with one or more actuators configured to spread a plume of residue during operation, the residue spread monitoring system comprising:
one or more sensors mounted to one or more locations on the agricultural harvester; and
a controller configured to:
receive one or more first images from the one or more sensors;
determine a mode of plume evaluation as a first mode of plume evaluation or a second mode of plume evaluation;
determine, when in the first mode of plume evaluation, a first spread of the plume of residue based on residue within the one or more first images;
measure, when in the second mode of plume evaluation, one or more first characteristics of dust represented in the one or more first images;
process, when in the second mode of plume evaluation, the one or more first characteristics of dust to obtain the first spread of the plume of residue; and
control operation of the agricultural harvester according to the first spread of the plume of residue.

2. The residue spread monitoring system of claim 1, wherein the controller is further configured to:
determine a visibility of the plume of residue from the one or more first images;
in response to determining that the visibility of the plume of residue satisfies a threshold condition as being visible, determine the mode of plume evaluation as the first mode of plume evaluation; and
in response to determining that the visibility of the plume of residue fails to satisfy the threshold condition such that the plume of residue is not visible in the one or more first images, determine the mode of plume evaluation as the second mode of plume evaluation.

3. The residue spread monitoring system of claim 1, wherein the one or more first characteristics of dust include at least one of location or movement.

4. The residue spread monitoring system of claim 1, wherein the first spread of the plume of residue includes at least one of a location, a width, or a direction of movement of the plume of residue.

5. The residue spread monitoring system of claim 1, wherein the controller is configured to control the operation of the agricultural harvester according to the first spread by controlling at least one of a speed or a position of a spreader mechanism.

6. The residue spread monitoring system of claim 1, wherein the controller is configured to control the operation of the agricultural harvester according to the first spread by controlling at least one of chopper operation, harvester speed, or a harvester head operation.

7. The residue spread monitoring system of claim 1, wherein the controller is further configured to:
receive one or more second images from the one or more sensors mounted to the agricultural harvester prior to receiving the one or more first images;
measure a second spread of a plume of residue of the agricultural harvester by analyzing the one or more second images;
identify dust represented in the one or more second images;
measure one or more second characteristics of the dust represented in the one or more second images;
train, using the second spread of the plume of residue and the one or more second characteristics, a spread prediction module to output a spread prediction for the plume of residue; and
in response to determining that the visibility of the plume of residue fails to satisfy the threshold condition such that the plume of residue is not visible in the one or more first images, process the one or more first characteristics of dust to obtain the first spread of the plume of residue by processing the one or more first characteristics using the spread prediction module.

8. The residue spread monitoring system of claim 1, wherein the one or more sensors include one or more cameras.

9. The residue spread monitoring system of claim 8, wherein the one or more cameras include at least one rearward pointing camera positioned above a spreader mechanism of the agricultural harvester.

10. A method for predicting residue spread by an agricultural harvester, comprising:
receiving, by a controller, one or more first images from one or more sensors mounted to the agricultural harvester;
determining, by the controller, a mode of plume evaluation as a first mode of plume evaluation or a second mode of plume evaluation;
determining, by the controller when in the first mode of plume evaluation, a first spread of the plume of residue based on residue within the one or more first images;
measuring, by the controller when in the second mode of plume evaluation, one or more first characteristics of dust represented in the one or more first images and processing, by the controller in the second mode of plume evaluation, the one or more first characteristics of dust to obtain a first spread of the plume of residue; and
controlling, by the controller, operation of the agricultural harvester according to the first spread.

11. The method of claim 10,
further comprising evaluating a visibility of the plume of residue from the one or more first images; and
wherein the determining, by the controller, the mode of plume evaluation as the first mode of plume evaluation or the second mode of plume evaluation includes:
determining the mode of plume evaluation as the first mode of plume evaluation when the visibility of the plume of residue satisfies a threshold condition as being visible; and
determining the mode of plume evaluation as the second mode of plume evaluation when the visibility of the plume of residue fails to satisfy the threshold condition such that the plume of residue is not visible in the one or more first images.

12. The method of claim 10, further comprising:
receiving, by the controller, one or more second images from the one or more sensors;
determining, by the controller, that the plume of residue emitted from the agricultural harvester is visible in the one or more second images; and
in response to determining that the plume of residue is visible in the one or more second images, determining a second spread of the plume of residue based on the residue within the one or more second images and controlling, by the controller, operation of the agricultural harvester according to the second spread.

13. The method of claim 10, wherein the one or more first characteristics include at least one of location or movement of dust.

14. The method of claim 10, wherein the first spread of the plume of residue includes at least one of a location, a width, or a direction of movement of the plume of residue.

15. The method of claim 10, further comprising controlling, by the controller, the operation of the agricultural harvester according to the first spread by controlling at least one of a speed or a direction of a spreader mechanism.

16. The method of claim 10, further comprising controlling, by the controller, the operation of the agricultural harvester according to the first spread by controlling one or more of chopper operation, harvester speed, or harvester head operation.

17. The method of claim 10, further comprising:
receiving, by the controller, one or more third images from the one or more sensors mounted to the agricultural harvester prior to receiving the one or more first images;
measuring, by the controller, a third spread of a plume of residue of the agricultural harvester by analyzing the one or more third images;
identifying, by the controller, dust represented in the one or more third images;
measuring, by the controller, one or more second characteristics of the dust represented in the one or more third images; and
training, by the controller, using the third spread of the plume of residue and the one or more second characteristics, a spread prediction module to output a spread prediction for the plume of residue;
wherein processing the one or more first characteristics to obtain the first spread of the plume of residue comprises processing, by the controller, the one or more first characteristics using the spread prediction module.

18. The method of claim 10, wherein the sensors include one or more cameras, including at least one rearward pointing camera positioned at a height greater than that of a spreader mechanism of the agricultural harvester.

19. A residue spread prediction system for an agricultural harvester, comprising:
one or more sensors mounted to one or more locations on the agricultural harvester; and
a controller configured to:
receive one or more first images from the one or more sensors;
measure a first spread of a plume of residue of the agricultural harvester by analyzing the one or more first images;
identify dust represented in the one or more first images;
measure one or more first characteristics of the dust represented in the one or more first images; and
train, using the first spread of the plume of residue and the one or more first characteristics, a spread prediction module to output a spread prediction for the plume of residue.

20. The residue spread prediction system of claim 19, wherein:
the one or more first characteristics include at least one of location or movement; and
the first spread of the plume of residue includes at least one of a location, a width, or a direction of the plume of residue.
